(19) United States
(12) Patent Application Publication
(10) Pub. No.: US 2006/0212422 A1
(43) Pub. Date: Sep. 21, 2006

(54) Efficiently executing commands against a large set of servers with near real time feedback of execution and presentation of the output of the commands

(76) Inventors: Anil Khilani, Sunnyvale, CA (US); Hasan Rizvi, San Carlos, CA (US); Harish Akali, Merrimack, NH (US); Karen McKeen, Amherst, NH (US)

Correspondence Address: HICKMAN PALERMO TRUONG & BECKER/ORACLE, 2055 GATEWAY PLACE, SUITE 550, SAN JOSE, CA, 95110-1089, US

(21) Appl. No.: 11/245,864

(22) Filed: Oct. 7, 2005

Related U.S. Application Data
(60) Provisional application No. 60/664,018, filed on Mar. 21, 2005.

(51) Int. Cl. G06F 17/30

(52) U.S. Cl. 707/2

(57) ABSTRACT

According to one embodiment of the invention, a technique is provided for interactive execution of commands on multiple computer targets. As the commands execute on the remote systems, the user receives feedback in real time. The feedback consists of the status of each command on each system and the output from each command executed on each system, among other items. The feedback is formatted in a user-friendly fashion to enable the user to quickly determine the status of the job, such as which systems have succeeded in executing the commands and which have failed. The feedback also indicates which systems are currently being operated on. The feedback may be viewed in real time as well as saved to a file for later viewing. In one embodiment, the user is also provided with a graphical user interface (GUI).

### FIELD OF THE INVENTION

The present invention relates to executing commands on multiple targets, and more specifically, executing commands simultaneously to a plurality of computer targets with immediate feedback on the status of the commands.

### BACKGROUND

Computer system administrators often are responsible for troubleshooting, maintenance and upgrades on a large number of computers, servers, clusters and/or databases. Administrators often perform these tasks by issuing commands remotely; for example, an administrator may be responsible for upgrading software components on a system comprised of hundreds of computers. These computers could be located a great distance away from the administrator, so the administrator must connect to the remote computers over a network. Once a connection is established, the administrator may execute commands which take effect on the target machine.

In the above example, it is extraordinarily time-consuming and inefficient for the administrator to perform the same tasks and commands on each system individually. If the tasks to be performed are of a critical nature, time may be of the essence. Administrators may be given a window of time within which to perform the required tasks. For example, busy web servers may be scheduled for maintenance and upgrades during a period of anticipated low activity. If the required changes are not made within that window of time, business could be lost if the web servers are not ready to be placed back into use during a period of high demand, or system corruption may occur if the systems are brought back online while the commands are still being executed.

One way for administrators to overcome these obstacles is the use of custom scripts. These scripts are often a program or sequence of instructions that is interpreted or carried out by another program, or operating system commands that are stored in a file and performed sequentially. One example would be a script which, when executed on a target machine over a network, would download a file from a remote location, decompress the file, execute the decompressed file, and restart the machine.

By using this custom script, an administrator could connect to a target machine, execute the script, and move on to the next target without the need to manually execute the commands serially for each machine. It is possible to create a script which automates the process, allowing the administrator to connect to multiple systems in order and execute a common set of commands on each machine.

There are several drawbacks to this approach. One, it takes time and expertise to create the scripts necessary to complete the tasks. Two, a new script often must be created for each new task to be executed. Three, there is no standardization or validation process for these custom scripts. Each administrator may approach the task differently; as a result, some approaches may work better than others, or some not at all. Four, the prior approaches do not offer feedback on the status of the job. Once a script terminates, the administrator is left with little to no certainty that the process was completed successfully. If one of the target machines was inaccessible, the administrator would not be aware of that fact. As a result, some machines may not be maintained or updated. Further, the commands may be delayed due to latency of the network connection or conditions inherent to the target machine. This could result in the commands being executed outside of an acceptable window within which the task needs to be completed. Even if feedback is available, it is often limited in scope and not organized in a coherent, usefull fashion. Further, it does not capture any output of the commands.

Consequently, there is a need for an improved technique that does not suffer from the shortcomings previously described.

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 a block diagram of a host computer connected to a group of targets in accordance with an embodiment of the invention;

FIG. 2 is a block diagram illustrating one embodiment of the invention utilizing a graphical user interface;

FIG. 3 is a block diagram illustrating one embodiment of the invention utilizing a graphical user interface;

FIG. 4 is a block diagram illustrating one embodiment of the invention utilizing a graphical user interface;

FIG. 5 is a block diagram illustrating one embodiment of the invention utilizing a graphical user interface

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Overview

According to techniques described herein, a system administrator may execute host commands or database statements contemporaneously on multiple systems or databases. The commands may be typed in via user interface, or loaded from a file containing the commands or SQL statements. Examples of “commands” include SQL statements, shell commands, instructions to execute commands, SQL*Plus commands, PL/SQL commands, and operating system commands.

As the commands execute on the remote systems, the user receives feedback in real time. The feedback consists of the status of each command on each system and the output from each command executed on each system, among other items. The feedback is formatted in a user-friendly fashion to enable the user to quickly determine the status of the job, such as which systems have succeeded in executing the commands and which have failed. The feedback also indicates which systems are currently being operated on. The feedback may be viewed in real time as well as saved to a file for later viewing.

The user is also provided with a graphical user interface (GUI) that allow for ease of use in entering commands to execute or choosing a file containing the commands. The GUI also provides a user-friendly way to cancel operations in progress, add or subtract systems to the ones already selected, view the availability of remote systems, store authentication credentials, and save results to a file, among other things.

IMPLEMENTATION

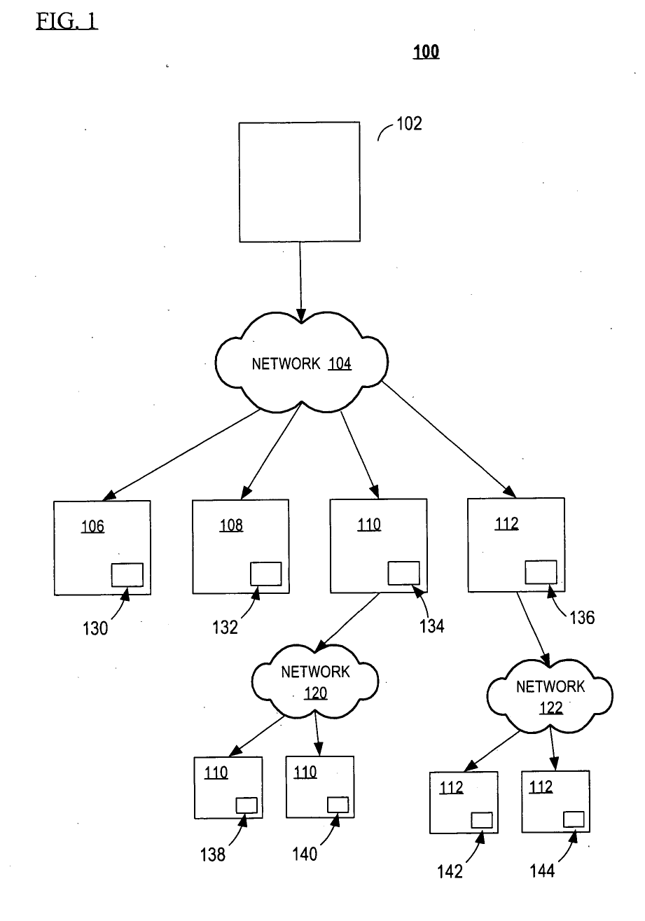

Referring to FIG. 1, a block diagram of a host computer connected to a group of targets in accordance with an embodiment of the invention 100. An administrator is operating a host computer system 102. The host computer 102 is connected to a network 104 over which it is possible to connect to the target machines 106-112. In one embodiment of the invention, the connection between the host computer 102 and the target machines 106-112 utilizes the Hypertext Transfer Protocol (HTTP). Other embodiments are envisioned where various network protocols other than HTTP are used to facilitate the connection between the host computer 102 and the target machines 106-112.

A target may consist of numerous single computers 106 all connected individually to the network 104. Another target may be a database system 108 running on a computer connected to the network 104. Another target may be a group of computers 110 all connected via a network such as a WAN or LAN 120. Another target may be a group of database systems 112 running on computers all connected via a network such as a WAN or LAN 122. In one embodiment of the invention, the targets may be homogeneous (containing targets of only one type) or heterogeneous (containing targets of different types).

In one embodiment of the invention, an administrator enters commands on the host computer 102 which are intended to be executed on the target machines 106-112. The commands may be entered in several different ways. One embodiment utilizes a command-line interface through which the administrator inputs the commands. The commands may be typed in or loaded from one or more files. Another embodiment utilizes a graphical user interface (GUI) through which the administrator operates, as described hereafter.

The administrator chooses the target machines 106-112 upon which the commands are to be executed. In one embodiment, the administrator is presented with a pre-populated list of potential target machines 106-112, while other embodiments envision automatic discovery of potential target machines 106-112 as well as manual entry of target machines.

Once the target machines 106-112 are selected and at least one command is ready for execution, a connection is initiated over the network 106 between the host machine 102 and the target machines 106-112. In another embodiment, a preexisting connection is utilized. The order of the actions is not limited to that described above.

In one embodiment, the administrator may then cause the commands to be executed on the target machines 106-112. In one embodiment, the commands are transmitted directly to the target machines for execution. In another embodiment, the commands are transmitted to a process 130-144 running on the target machines 106-112, which then controls the execution of the commands on the target machines 106-112. This process, or agent, acts as an intermediary between the host machine 102 and the target machines 106-112.

In the preferred embodiment, the commands are transmitted to and executed upon the target machines 106-112 in parallel and contemporaneously. It is envisioned that the commands may not be transmitted at the same time. It is further envisioned that the commands will not be executed on the target machines 106-112 at the same time. As a result, contemporaneously means preferably at the same approximate time and preferably in parallel.

In one embodiment, it is necessary to provide authentication information to the target machines 106-112 in order to connect to the machines or databases. In one embodiment, this information is communicated as part of establishing the connection between the host machine 102 and the target machines 106-112. In another embodiment, this information is communicated as part of the execution of the commands.

In addition to communicating with and executing commands on target machines 106-112, an administrator may copy files from the host computer 102 to at least one of the target machines 106-112, in parallel and contemporaneously.

As the commands are executed on the target machines 106-112, feedback is provided to the user. In one embodiment, this feedback is in real-time as the commands are executed. The feedback apprises the user of the status of each command on each target machine. In one embodiment, the feedback summarizes information such as: how many target machines have successfully executed the commands; how many target machines have failed to execute the commands; how many target machines are still processing the commands; and on which target machines the commands are currently being executed. Other types of feedback are envisioned. In one embodiment, this feedback is refreshed with up-to-date information on a real-time basis. In other embodiments, the feedback is refreshed at periodic intervals, which may be user-defined.

In one embodiment, the feedback additionally includes the actual output of the command being executed on each specific target machine. This feedback and command output may be provided on a single scrollable page to facilitate ease of reading and comprehension. It is possible that the output from the target machines may consist of several, even hundreds of pages of data. One embodiment displays only the top x number of lines of output, where x is a user-defined number. Other types of feedback envisioned include performance statistics such as the time the commands took to execute on each target machine.

In one embodiment of the invention, as soon as the command completes on any target machine, the administrator may open a second window and check the actual output of the command. The administrator may then make a decision to either approve of the command and wait for the rest of the target machines to finish the command or task, or cancel the job and change the command, or start a secondary command on the target machines that have completed the initial commands.

One example of an embodiment of the invention is as follows. An administrator desires to execute the SQL statement “SELECT * FROM CUSTOMERS” on 100 database systems located in various parts of the world. The administrator may use a command-line interface or GUI to input the command on the host machine, or may open a file containing the command. The administrator selects the specific database systems on which to execute the command, either through the use of a command-line interface or GUI. The administrator establishes a network connection between the host machine and the target machines and initiates the execution of the command.

In one embodiment, the host machine connects directly to the database systems and directly executes the command. In another embodiment, the host machine interfaces with a process, or agent, on the target machines. The target then executes the command. This process preferably takes place contemporaneously and in parallel. As the command is executing on the target machines, feedback is generated and received at the host machine. In one embodiment, this feedback comprises the status of the commands on each individual target machine, the success, failure or currently executing status of the commands, and which target machines are currently being operated on. This feedback may be in real-time or refresh at periodic user-selected intervals.

In one embodiment, the result of the command on each target machine is returned to the host machine. As the sample command is selecting all rows in a specific table, the output could be quite large. This output may be reproduced in its entirety or the top x number of lines of output, where x is a user-defined number.

In one embodiment, the administrator may select a subset of the original target machines and execute a new command on them while the original job is still running. The user may also add target machines to be included in the job or delete target machines from the current job or a future job.

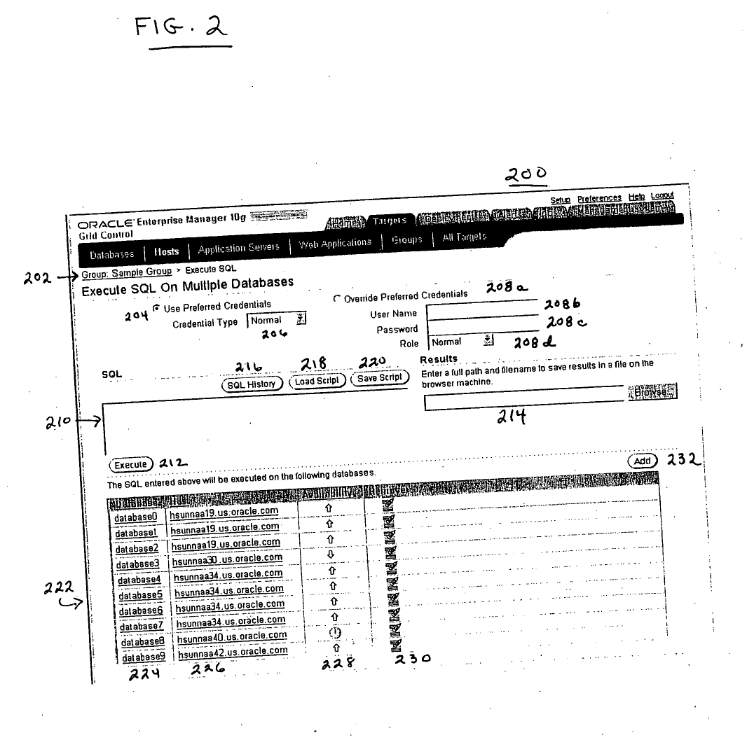

Referring now to FIG. 2, it is a block diagram 200 illustrating one embodiment of the invention utilizing a graphical user interface wherein commands have yet to be initiated. In this embodiment, commands may be executed on a database or group of database systems. If the embodiment is launched in the context of a database system, a breadcrumb-type element 202 displays the name of the database and in one embodiment is a hyperlink that, when clicked, returns to the homepage for the database. If the embodiment is launched in the context of a group of machines or database systems, the breadcrumb 202 displays the name of the group and in one embodiment is a hyperlink that, when clicked, returns to the homepage of the group or the appropriate homepage element.

Authentication may be needed to execute commands on certain systems. In one embodiment, the administrator is presented with a choice between using preferred credentials or overriding the preferred credentials. Credentials are used in an authentication process, a system connection process, or a database login process. In one embodiment of the invention, the “use preferred credentials” 204 selection is the default. Using this option indicates that the preferred credentials for each database will be used. In this embodiment, a drop-down selection box 206 determines whether the “Normal” credentials or the SYSDBA credentials will be used.

In one embodiment, a means is provided to override preferred credentials 208a. This option indicates that the specified credentials such as User Name 208b, Password 208c, and Role 208d will be used instead of the preferred credentials. In one embodiment, the specified credentials will be used for each database.

In one embodiment, the administrator is provided with a text input box 210 within which to enter commands or SQL statements, or both, to be executed. A button 212 or other interface element is clicked on or otherwise selected to begin the execution process. In one embodiment, a processing page, as discussed herein, will appear while the commands are executed on the targets. Upon execution of the commands, results of the commands will be displayed in a results page as discussed herein. If the user desires to save the results to a file, a file name and path may be entered 214 or a currently-existing file may be chosen within which to append the results of the operations.

In one embodiment, all SQL or other commands that have been executed in the current session may be accessed. The user may load the command input window 210 with the contents of a file 218 as well as saving the text in the command input window 210 to a file 220.

A table of systems or database systems 222 is provided in one embodiment. This table displays information about the systems or databases on which the commands or SQL statements will be executed. In one embodiment, the information consists of the target name of the system or database system 224, the host name for each system or database system 226, the current availability of each system or database system 228, and a means to remove the system or database system from the table 230. The target name for each system or database 224 may be sorted. In this embodiment, each name is a link that, when clicked, displays the homepage for the system or database. The host name 226 for each system or database may be sorted. Each host name 226 is a link that, when clicked, displays the homepage for the host. The current availability of the database or system 228 may be sorted. Each availability icon 228 is a link that, when clicked, displays the availability page for the system or database. Databases and systems may be added 232 to the table of systems or databases 222.

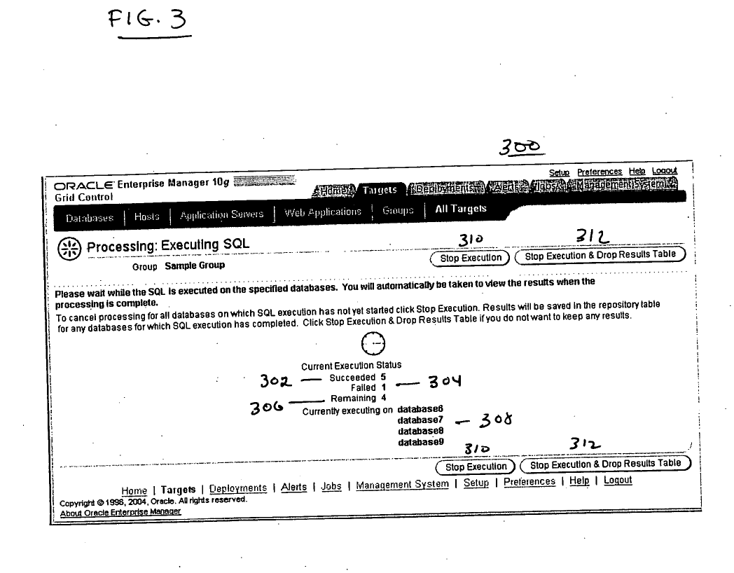

FIG. 3 is a block diagram illustrating one embodiment of the invention utilizing a graphical user interface wherein commands are in the process of execution. In this embodiment, when the execution process is initiated, a processing page 300 is displayed while the commands are executed. According to one embodiment, SQL execution is multi-threaded to handle multiple databases. The processing page 300 is automatically updated to indicate the progress. In one embodiment, the user is presented with information on current execution status such as: the number of targets that have successfully completed the commands 302, the number of targets that have failed in an attempt to complete the commands 304, the number of targets that have yet to complete the commands 306, and which targets are currently executing the commands 308.

In one embodiment, a button 310 or other interface element is clicked on or otherwise selected to cancel the execution process. In one embodiment, command execution will continue to completion for any targets that are listed as currently executing 308, but commands will not begin on any targets where they have yet to initiate. In one embodiment, a confirmation message is provided to alert the user that the execution process has been cancelled.

In one embodiment, if a user desired to save the results to a file 214, a button or other interface element 312 is provided to cancel the execution process and save whatever results have been generated from the beginning of the process to the point of cancellation on each target.

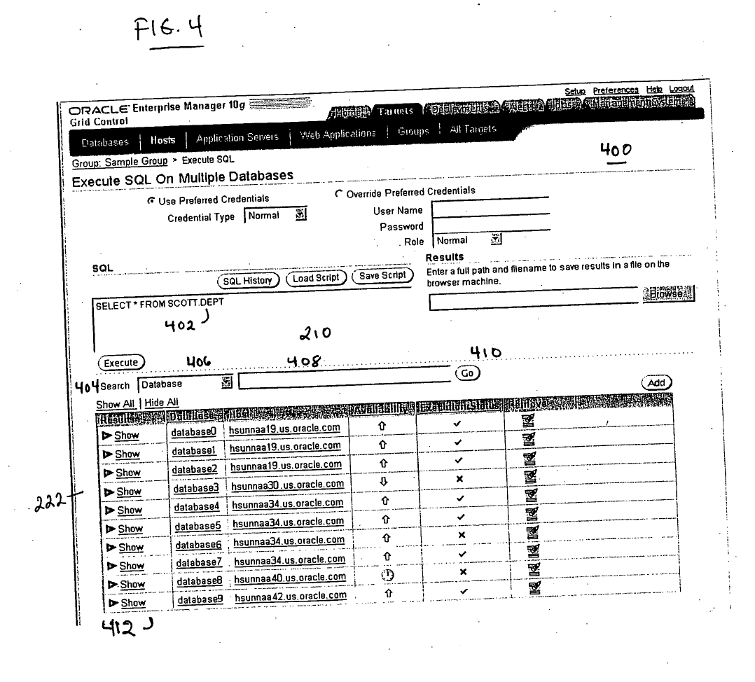

FIG. 4 is a block diagram illustrating one embodiment of the invention utilizing a graphical user interface wherein execution of the commands has been completed or cancelled. The user is presented with the display as illustrated in FIG. 2, with additional elements 400. In one embodiment, the text input box 210 contains the commands that were executed 402. The commands may be executed again via the interface element to initiate the execution process 212.

In one embodiment, a search capability 404 is provided with a dropdown menu 406 and text input field 408 with an interface element to begin the search 410. According to one embodiment, the search capability is used to filter the rows in the table of systems or database systems 222 to locate results for specific systems or database systems. In one embodiment, the dropdown menu 406 includes choices: database system or system, execution status good, and execution status bad. Through these choices, the search may be limited to the selected target or characteristic.

The table of systems or database systems 222 is similar to that illustrated in FIG. 2, with some differences. In one embodiment, a link is provided 412 to “show” or “hide” execution result details for the corresponding system or database system, as discussed herein. In one embodiment, information is provided regarding the execution status 414 of each system or database system. The information indicates success or failure, and may be sorted.

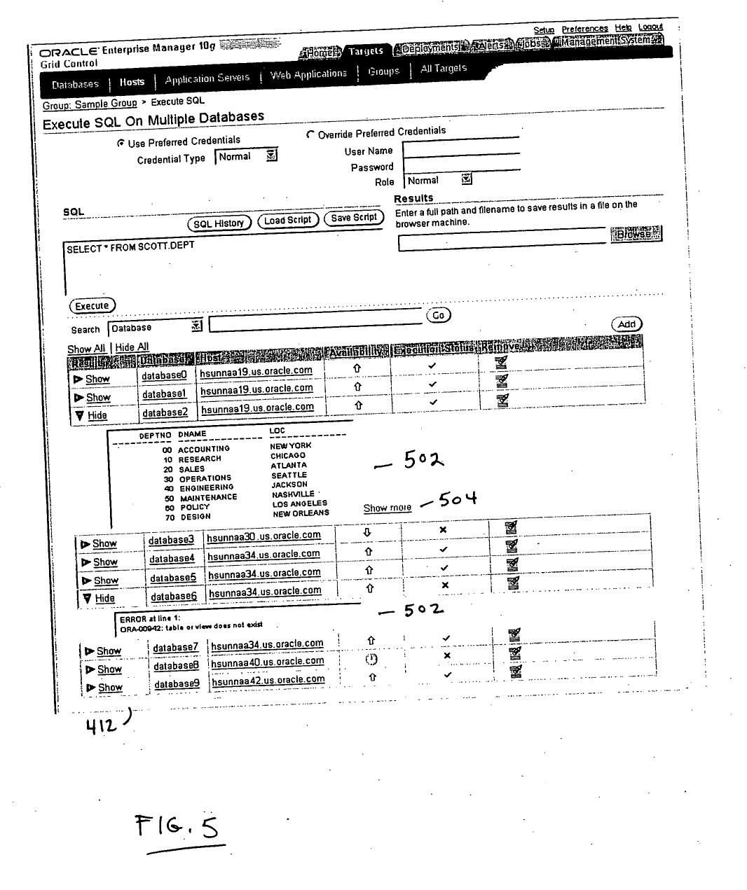

FIG. 5 is a block diagram illustrating one embodiment of the invention utilizing a graphical user interface wherein execution of the commands has been completed or cancelled and execution result details are provided. The user is presented with the display as illustrated in FIG. 4, with additional elements 500. In one embodiment, if the “show” link 412 is selected, the corresponding row will expand and a nested text box 502 will be displayed. In one embodiment, the nested text box 502 will display up to ten lines returned from the command execution. If more than ten lines are returned, a link 504 will be displayed which when selected displays a page that shows a subset or the entirety of the execution results. Other embodiments are envisioned where differing amounts of lines are returned. In one embodiment, the amount is user-defined.

HARDWARE OVERVIEW

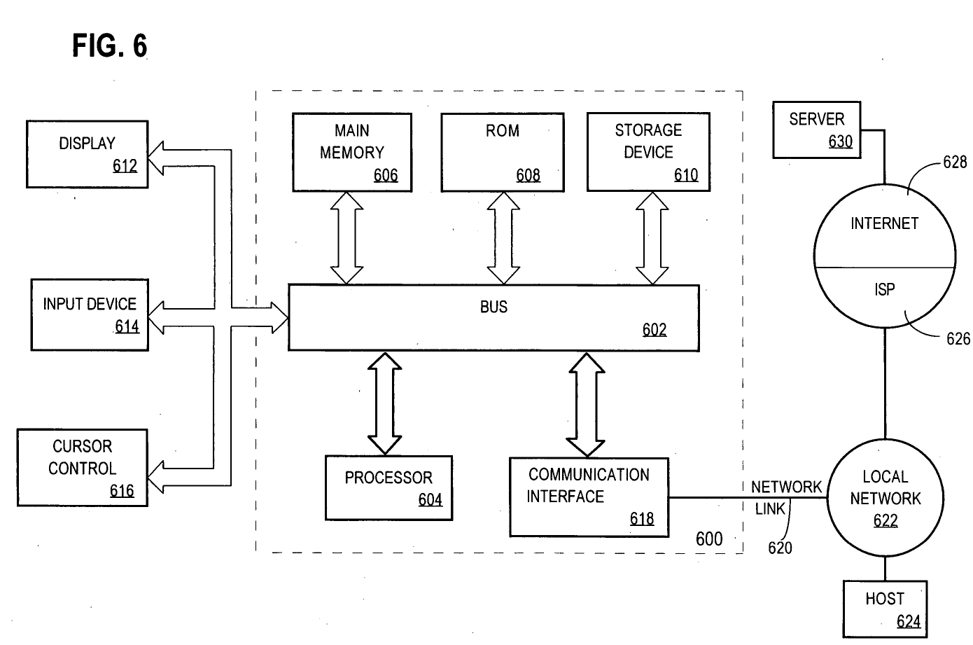

FIG. 6 is a block diagram that illustrates a computer system 600 upon which an embodiment of the invention may be implemented. A computer system as illustrated in FIG. 6 is but one possible system on which embodiments of the invention may be implemented and practiced. For example, embodiments of the invention may be implemented on any suitably configured device, such as a handheld or otherwise portable device, a desktop device, a set-top device, a networked device, and the like, configured for containing and/or playing digital video. Hence, all of the components that are illustrated and described in reference to FIG. 6 are not necessary for implementing embodiments of the invention.

Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk, optical disk, or magneto-optical disk, is provided and coupled to bus 602 for storing information and instructions.

Computer system 600 may be coupled via bus 602 to a display 612, such as a cathode ray tube (CRT) or a liquid crystal display (LCD), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

The invention is related to the use of computer system 600 for implementing the techniques described herein. According to one embodiment of the invention, those techniques are performed by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 604 for execution. Such a medium may take many forms, including but not limited to, non-volatile media, volatile media, and transmission media. Non-volatile media includes, for example, optical, magnetic, or magneto-optical disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution. In this manner, computer system 600 may obtain application code in the form of a carrier wave.

EXTENSIONS AND ALTERNATIVES

Alternative embodiments of the invention are described throughout the foregoing description, and in locations that best facilitate understanding the context of the embodiments. Furthermore, the invention has been described with reference to specific embodiments thereof. It will, however, be evident that various modifications and changes may be made thereto without departing from the broader spirit and scope of the invention. Therefore, the specification and drawings are, accordingly, to be regarded in an illustrative rather than a restrictive sense.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

Further, in the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for interactive execution of commands on multiple computer targets, the method comprising:
receiving at a host machine from a user through a user interface, at least one command to be executed on a plurality of computer targets;
establishing a connection between the host machine and the plurality of computer targets;
causing the at least one command to be executed on the plurality of computer targets contemporaneously; and
displaying, for each of the plurality of computer targets, information in the user interface about the status of the commands being executed on said each of the plurality of computer targets.

2. The method of claim 1, wherein the computer targets are database systems.

3. The method of claim 1, wherein the at least one command specifies to execute commands in a file.

4. The method of claim 1, wherein the at least one command comprises a database statement.

5. The method of claim 4, wherein the database statements comprise SQL statements.

6. The method of claim 1, further comprising providing authentication information to at least one of the plurality of computer targets.

7. The method of claim 1, wherein the feedback further comprises output generated by the commands being executed.

8. The method of claim 1, wherein the commands being executed on the plurality of targets may be cancelled or suspended via the user interface.

9. The method of claim 1, wherein the commands being executed on the plurality of machines may be cancelled or suspended individually for each target via the user interface.

10. The method of claim 1, wherein the feedback further comprises the amount of time elapsed between the time the at least one command began executing on at least one of the plurality of computer targets and the time the at least one command completed execution on at least one of the plurality of computer targets.

11. The method of claim 1, wherein the feedback may be saved to a file.

12. The method of claim 1, further comprising creating a second plurality of computer targets by interactively adding or removing computer targets to the initial plurality of computer targets during or after the execution of the initial commands on the initial plurality of computer targets, then causing at least one command to be executed contemporaneously on the second plurality of computer targets.

13. The method of claim 1, further comprising causing at least one preliminary command to be executed on a subset of the plurality of computer targets prior to causing the at least one command to be executed on the plurality of computer targets.

14. The method of claim 13, wherein the preliminary command comprises SQL statements.

15. The method of claim 1, further comprising:
during the execution of the commands on the plurality of computer targets,
receiving a second set of commands;
selecting a second set of computer targets comprising at least one computer target on which the first commands have been completed; and
causing the second set of commands to be executed on the second set of computer targets.

16. A computer-readable medium carrying one or more sequences of instructions which, when executed by one or more processors, causes the one or more processors to perform the steps of:
receiving at a host machine from a user through a user interface, at least one command to be executed on a plurality of computer targets;
establishing a connection between the host machine and the plurality of computer targets;
causing the at least one command to be executed on the plurality of computer targets contemporaneously; and
displaying, for each of the plurality of computer targets, information in the user interface about the status of the commands being executed on said each of the plurality of computer targets.

17. A computer-readable medium carrying one or more sequences of instructions which, when executed by one or more processors, causes the one or more processors to perform the method recited in claim 2.

18. A computer-readable medium carrying one or more sequences of instructions which, when executed by one or more processors, causes the one or more processors to perform the method recited in claim 3.

19. A computer-readable medium carrying one or more sequences of instructions which, when executed by one or more processors, causes the one or more processors to perform the method recited in claim 4.

20. A computer-readable medium carrying one or more sequences of instructions which, when executed by one or more processors, causes the one or more processors to perform the method recited in claim 5.

21. A computer-readable medium carrying one or more sequences of instructions which, when executed by one or more processors, causes the one or more processors to perform the method recited in claim 6.

22. A computer-readable medium carrying one or more sequences of instructions which, when executed by one or more processors, causes the one or more processors to perform the method recited in claim 7.

23. A computer-readable medium carrying one or more sequences of instructions which, when executed by one or more processors, causes the one or more processors to perform the method recited in claim 8.

24. A computer-readable medium carrying one or more sequences of instructions which, when executed by one or more processors, causes the one or more processors to perform the method recited in claim 9.

25. A computer-readable medium carrying one or more sequences of instructions which, when executed by one or more processors, causes the one or more processors to perform the method recited in claim 10.

26. A computer-readable medium carrying one or more sequences of instructions which, when executed by one or more processors, causes the one or more processors to perform the method recited in claim 11.

27. A computer-readable medium carrying one or more sequences of instructions which, when executed by one or more processors, causes the one or more processors to perform the method recited in claim 12.

28. A computer-readable medium carrying one or more sequences of instructions which, when executed by one or more processors, causes the one or more processors to perform the method recited in claim 13.

29. A computer-readable medium carrying one or more sequences of instructions which, when executed by one or more processors, causes the one or more processors to perform the method recited in claim 14.

30. A computer-readable medium carrying one or more sequences of instructions which, when executed by one or more processors, causes the one or more processors to perform the method recited in claim 15.
